(19) United States
(12) Patent Application Publication
(10) Pub. No.: US 2026/0102014 A1
(43) Pub. Date: Apr. 16, 2026

(54) COOKWARE INSERT

(71) Applicant: Lisette Rodriguez, Miami, FL (US)

(72) Inventor: Lisette Rodriguez, Miami, FL (US)

(21) Appl. No.: 19/359,053

(22) Filed: Oct. 15, 2025

Related U.S. Application Data
(60) Provisional application No. 63/707,582, filed on Oct. 15, 2024.

(51) Int. Cl. A47J 36/16

(52) U.S. Cl. CPC A47J 36/16

(57) ABSTRACT

A cookware insert that defines multiple compartments within a cooking space of cookware is disclosed. The cookware insert provides a plurality of divider walls that fluidly separates adjacent compartments of the cooking space circumscribed by the cookware insert. Being separated by a divider wall, each compartment can cook different ingredients and food combinations at the same time and within the same cookware without concern for the food stuff of one compartment permeating the cooking space of adjacent compartments. Through a flush alignment of the lower surfaces of each of the plurality of divider walls for each cookware insert, the individualized divider wall structures prevent transmission of liquids between adjacent compartments. For storage purposes, each cookware insert provides a central receptacle and locking elements for engaging handle elements and divider walls, respectively, of a subjacent cookware insert in a vertical stacking arrangement thereto.

### CROSS REFERENCE TO RELATED APPLICATION

This application claims the benefit of priority of U.S. provisional application No. 63/707,582, filed Oct. 15, 2024, the contents of which are herein incorporated by reference.

### BACKGROUND OF THE SUBJECT DISCLOSURE

The present subject disclosure relates to cookware and, more particularly, to a cookware insert defining multiple compartments within a piece of cookware for cooking a variety of different ingredients and food combinations at the same time and within the same cookware.

The term ‘cookware’ is to be understood to refer to food preparation equipment, such as cooking pots, pans, baking sheets, etc. used in kitchens on a stove or range cooktop; though, in some embodiments the term cookware could be synonymous with bakeware preparation equipment used in an oven.

Preparing homemade baby food using traditional methods poses several challenges that can discourage parents and caregivers from opting for this healthier alternative. The process typically requires cooking multiple small portions of different foods to provide the essential nutritional variety for a baby's diet. This often involves using multiple pots and pans for steaming, boiling, or simmering individual ingredients, such as vegetables, grains, and proteins. As a result, the time spent managing various cooking tasks significantly increases, with each food requiring careful monitoring to ensure it is cooked appropriately. The need for multiple cookware items not only complicates meal preparation but also leads to an excessive number of dishes to clean afterward, making the process even more exhausting. Moreover, the inefficiency of this method can deter busy parents or caregivers from preparing homemade baby food altogether, leading them to rely on pre-packaged or store-bought options that may lack the same level of freshness, customization, and nutritional value.

Prior devices or systems in the culinary field lack effective leak-proof designs, leading to cross-contamination between compartments, and often fail to efficiently accommodate the simultaneous cooking of diverse foods; specifically, their lack of proper sealing allows food content, liquids, and flavors to mix, compromising the quality and separation of foods. Additionally, most are not modular or stackable, limiting their scalability and practicality for preparing small portions or multiple meals at once. In sum, their fixed designs and inability to stack or expand limit their versatility and efficiency, making them unsuitable for preparing diverse or small-portion meals simultaneously.

As can be seen, there is a need for a cookware solution that simplifies and streamlines the process of cooking small, diverse portions of food simultaneously, reducing both time and effort while maintaining the benefits of homemade meals.

### SUMMARY OF THE SUBJECT DISCLOSURE

The subject disclosure is designed not to leak into surrounding compartments and outside of the inserts.

The subject disclosure is also stackable and can be combined with additional inserts of the same product.

The subject disclosure incorporates leak-proof compartments that keep foods separate, preserving their quality and integrity. The subject disclosure is stackable design enhances versatility and efficiency, allowing users to cook multiple meals or components simultaneously while reducing the need for extra cookware and cleanup. It should be understood that even though homemade baby food can be one use case, it is not the only use case as the subject disclosure is a boon for a myriad of cooking options.

The subject disclosure embodies cooking pot inserts that solve these challenges by providing a convenient, efficient, and user-friendly solution for preparing homemade baby food as well as general cooking and preparation possibilities, including but not limited to camping, general meal preparation, baking, creative projects and scientific experimentation. Designed with multiple leak-proof compartments, the cookware insert allows users to cook a variety of different foods simultaneously in a single pot. This eliminates the need for multiple pots and pans, significantly reducing both the time and effort required for meal preparation and cleanup. Each compartment is designed to prevent leakage between sections, ensuring that nutrients, flavors and liquids remain separate. This feature is particularly important for cooking small portions.

The stackable design allows users to expand their cooking capacity by using multiple inserts at once, enabling the preparation of multiple meals or components in one session. The insert's compact and easy-to-use structure promotes efficiency by streamlining the cooking process, making the cooking process more manageable. By addressing the logistical and time constraints of traditional methods, the product empowers users to create fresh, healthy, and customized meals with ease, encouraging a shift toward more homecooked food options and improved nutrition and health outcomes.

The subject disclosure stands out in its field due to its unique combination of multiple leak-proof compartments and a stackable design, which allows for simultaneous cooking of various foods without cross-contamination. Unlike existing products, it eliminates the need for multiple pots and pans, offering unparalleled convenience, efficiency, and scalability for healthier, homecooked meal preparation.

In one aspect of the subject disclosure, a cookware insert provides the following: a base wall dimensioned and shaped to circumscribe a portion of a contained volume a cookware; a plurality of divider walls extending from the base wall and dividing the portion of the contained volume into a plurality of compartments; and the lower surface of each divider wall of the plurality of divider walls having a flush alignment relative to each other so that fluids contained by one compartment of the plurality of compartments is prevented from migrating to an adjacent compartment of the plurality of compartments.

In another aspect of the subject disclosure, the cookware insert further provides, wherein the base wall and the plurality of divider walls are sufficiently heat resistant for cooking various food stuff in the plurality of compartments; a hub centrally disposed in the portion of a contained volume the cookware, wherein the plurality of divider walls terminate at the central hub; a handle portion projecting from the beyond an upper surface of the plurality of divider walls; a nesting receptacle defined by the hub; a lower edge of the base wall providing a series of locking grooves.

In yet another aspect of the subject disclosure, a cookware insert system includes two or more aforesaid cookware inserts dimensioned and shaped so that each of the two or more said cookware inserts form a nested condition when in a vertically stacked arrangement, wherein a handle portion of a subjacent cookware insert of the two or more said cookware inserts is received within a nesting receptacle of a suprajacent cookware insert of the two or more said cookware inserts, and wherein one or more of the series of locking grooves of said suprajacent cookware insert engages one of the plurality of divider walls.

These and other features, aspects and advantages of the present subject disclosure will become better understood with reference to the following drawings, description and claims.

### BRIEF DESCRIPTION OF THE DRAWINGS

FIG. 1 is a perspective view of an exemplary embodiment of the subject disclosure.

FIG. 2 is an exploded perspective view of an exemplary embodiment of the subject disclosure.

FIG. 3 is a top plan view of an exemplary embodiment of the subject disclosure, illustrating a cookware insert 20 having spoke-like divider walls 22 extending from a hub (that supports an upper handle 26) to interior surfaces of the base frame 21, thereby defining a plurality of compartments 24. At frame connection points 27, flared or divided panels may be provided to add strength and lightness.

FIG. 4 is a top plan view of an exemplary embodiment of the subject disclosure, illustrating a cookware insert 30 having bisecting divider walls 32 extending from a hub (that supports an upper handle 36) to opposing interior surfaces of the base frame 31, thereby defining a plurality of compartments 34. At frame connection points 37, flared or divided panels may be provided to add strength and lightness.

FIG. 5 is a top plan view of an exemplary embodiment of the subject disclosure, illustrating a cookware insert 40 having honeycomb-like divider walls 42 extending from a hub (that supports an upper handle 46) to interior surfaces of the base frame 41, thereby defining a plurality of compartments 44. At frame connection points 47, flared or divided panels may be provided to add strength and lightness. At hub connection points 49, triangular panels may be provided to add strength and lightness.

FIG. 6 is a perspective view of an exemplary embodiment of the subject disclosure, illustrating a cookware insert 60 having divider walls 22 extending from a hub 67 (that supports an upper handle 66) to interior surfaces of the base frame, thereby defining a plurality of compartments 64, shown in a stacked orientation with a cookware insert 70 and a cookware insert 80.

FIG. 7 is an exploded top perspective view of an exemplary embodiment of the subject disclosure, further illustrating the stacked orientation of FIG. 6.

FIG. 8 is an exploded bottom perspective view of an exemplary embodiment of the subject disclosure.

FIG. 9 is a section view taken along line 9-9 of FIG. 6, further illustrating the stacked orientation and showing illustrating a hub 77 (that supports an upper handle 76) and a hub 87 of the cookware insert 80, wherein the hubs 87 upper handle 86 is dimensioned and adapted to nest in the nesting receptacle of hub 77 of cookware insert 70. The engagement of the locking grooves, 65, and 75, respectively, and the divider walls of the subjacent cookware insert are also shown.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

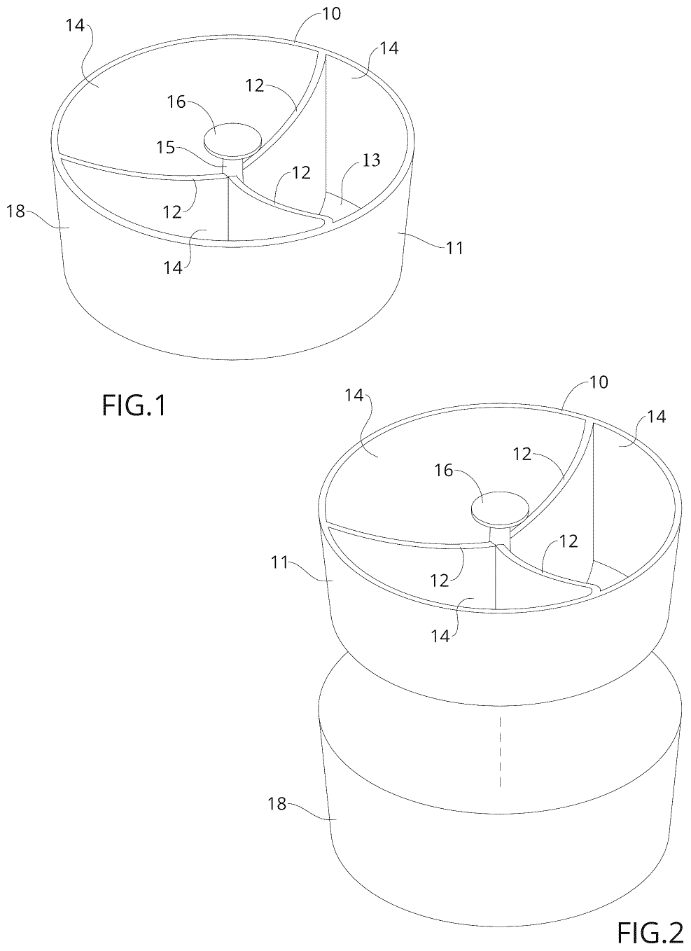

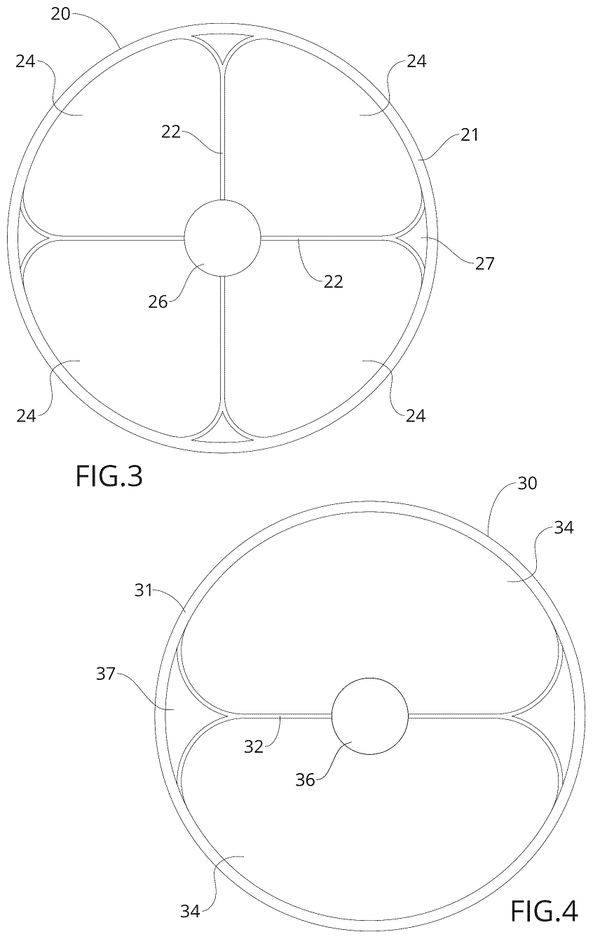

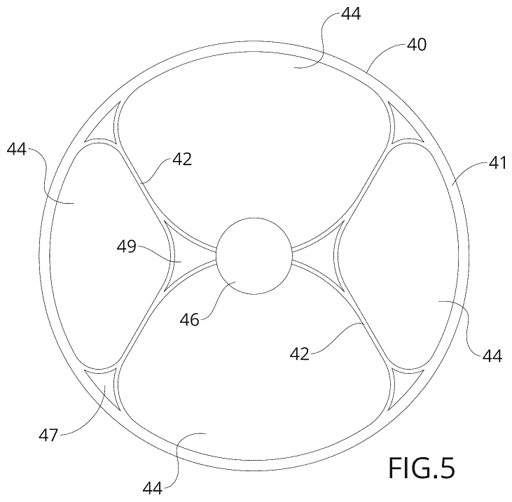

Referring to FIGS. 1 and 2, the subject disclosure provides cookware insert 10. Cookware insert 10 includes a base frame 11 circumscribing a volume of space typically within cookware 18; though the cookware insert can be used independently without cookware (e.g., in a double boiler, microwave, baking, etc.). A plurality of divider walls 12 occupies the volume of circumscribed space to define a plurality of compartments 14 therein. Each divider wall 12 extends from an interior surface of the base frame 11 to another point along the base frame 11 or to a central hub 15. Extending from the top end of the central hub 15 may be a handle 16 that protrudes about an upper elevation of the base frame 11. In other words, in use, the handle 16 projects to an elevation that is at least one inch higher than an elevation of the base frame 11.

Base frame 11 of the cookware insert 10 supports all compartments 14 and ensures stability within circumscribed space of the base frame 11. The base frame 11 may be different geometric shapes, even though only cylindrical shapes are shown in the Figures. In other words, the cookware insert 10 may be dimensioned and shaped to fit within variously shaped and sized cookware 18, such as but not limited to a cooking pot, as long as each compartment is designed for cooking separate portions of food therein. In some embodiments, the cookware insert 10 could be rectangular and fit within the workspace of a pan or baking sheet.

The cookware insert 10 has compact storage features, such as collapsible or nestable design elements for easy storage when the cookware insert 10 is not in use. The cookware insert 10 may have the aforementioned handle 16 or heat-resistant grip point for safe and easy insertion and removal from the subject cookware 18.

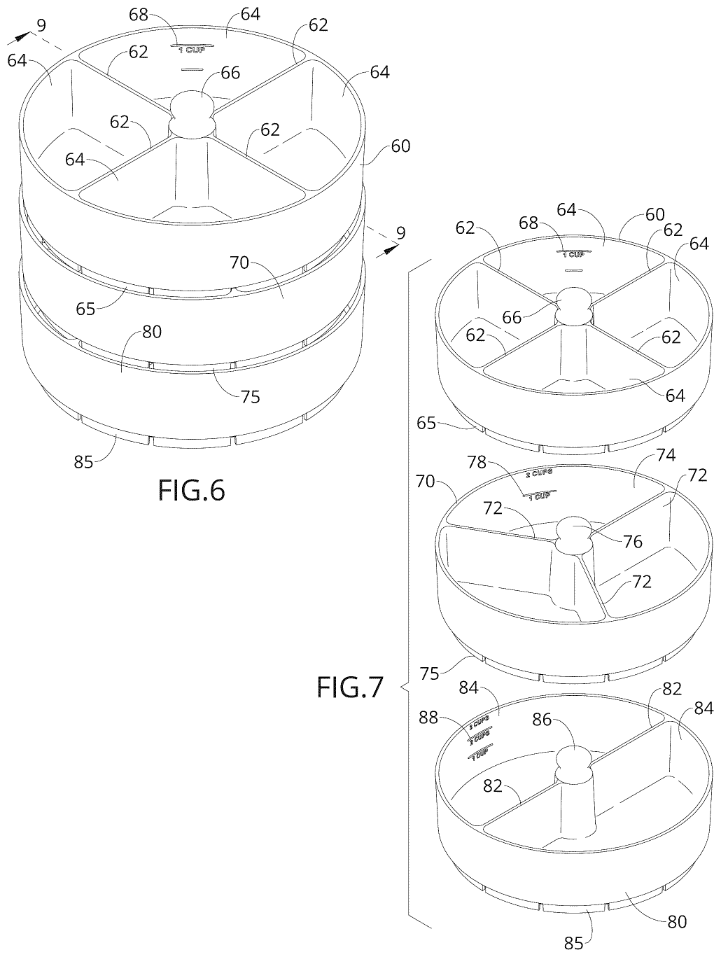

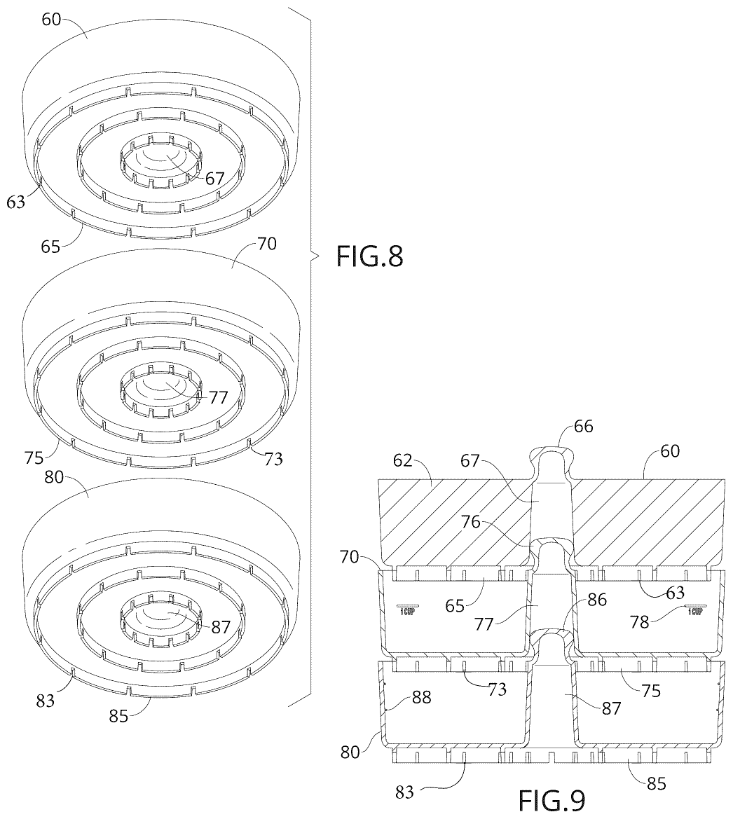

Referring to FIGS. 6 through 9, some embodiments provide a unique locking system allowing multiple inserts (60, 70, and 80) to be connected securely when stacked vertically, ensuring stability during use and preventing movement or tipping. The locking system embodies a locking mechanism incorporating interlocking grooves (63, 73, and 83 in FIGS. 8 and 9) provide along base rings 65, 75, and 85, respectively. The interlocking grooves are dimensioned and sized to receive an upper edge of the divider walls of a subjacent, vertically stacked cookware insert. These interlocking grooves 63, 73, and 83 allow multiple cookware inserts 60, 70, 80 to be securely stacked on top of one another, wherein these interlocking grooves 63, 73, and 83 also act as stacking alignment features. The interlocking grooves define locking segments that surround the lower base rings 65, 75, and 85 of the inserts to offer rigid base stability.

Graduated markings 68, 78, and 88 inside each compartment to assist with portion control and ingredient measurement. A textured or rubberized bottom layer may be provided to prevent the insert from shifting within the pot during use.

A rigid, heat-resistant support ring or plate at the bottom of cookware insert 10 may be provided to ensure even weight distribution and prevent warping during use.

The base frame 11 serves as the foundational structure that supports individual compartments 14 and ensures they remain stable within the cookware 18. The base frame 11 connects directly to the support ring or base plate for even weight distribution. The non-slip base may be a textured layer affixed to the bottom of the support ring or base plate. This feature prevents the insert from shifting or sliding within the receiving cookware 18, ensuring stability during use. The divider walls 12 may be secured to the base frame 11 to ensure each section remains independent. Each individual compartment 14 may be set flush relative to adjacent compartments 14, thereby obviating the need for drain holes or seals.

Measurement markings may be precision-etched or molded indicators located on the interior walls of each individual compartment 14. These graduated markings are measured in standard units (e.g., cups) to help users accurately portion ingredients directly within the compartments. The markings are designed to remain visible even after prolonged use and washing, ensuring convenience and consistency in meal preparation. Handles or grip points 16 attached to the base frame 11, enable safe and easy removal of the insert from the cooking pot. These are designed to stay cool during use for added safety.

Referring to FIGS. 8 and 9, for each cookware insert 60, 70, and 80, a nesting opening along the lower base of each so as to communicate with a nesting receptacle 67, 77, and 87. Each nesting receptacle 67, 77, and 87 is dimensioned and sized to slidably receive the handle or grip points 66, 76, and 86, respectively, of the subjacent cookware insert 60, 70, and 80.

The stacking alignment features may be integrated into the base frame 11 and individual compartments 14 to allow multiple inserts to be stacked securely. They work in conjunction with the interlocking mechanism for enhanced stability. Interlocking mechanism links stacked inserts together, ensuring that they do not shift or tip during use. It aligns with the stacking alignment features to create a secure multi-layer configuration. Additionally, compact storage features allow the insert and its component to be conveniently stored when not in use.

The cookware insert 10 may include several carefully designed components that work together to achieve its purpose. The base frame 11 provides structural support and ensures stability by securely fitting into standard cooking pots. Individual compartments 14 defined by dividing walls 12, made of food-grade silicone, stainless-steel, and other materials that can withstand cooking temperatures of over four-hundred degrees without degrading, thereby allowing for the simultaneous cooking of different foods in separate sections, saving time and effort.

These compartments 14 are closed off along the bottom surface 13 of the cookware insert 10, preventing ingredient liquid flavors from individual compartments from crossing between compartments or escaping the cookware insert 10 or passing from one compartment 14 to an adjacent compartment through the individualized wall structures, maintaining food integrity. In some embodiments, there may be no bottom surface 13, and the alignment of a bottom surface of each of the divider walls may prevent contamination between compartments.

To enhance usability, handles 16 or grip points enable safe handling for easy insertion and removal from the pot, while stacking alignment features allow multiple inserts to stack securely for increased cooking capacity. An interlocking mechanism ensures stacked inserts remain stable during use. The measurement markings etched inside each compartment provide precise portion control, while the non-slip base prevents the insert from sliding during cooking, enhancing safety. The support ring or base plate evenly distributes weight to keep the insert level. Compact storage features allow components to nest or collapse for easy storage, making the product user-friendly and space efficient.

The individual components of the cooking pot insert function seamlessly as a unified system to deliver efficient, safe, and convenient cooking. The individual compartments 14 work individually, yet together, to enable simultaneous cooking of multiple foods without cross-contamination of flavors or liquids, while maintaining the integrity of individual compartment encasing. The non-slip base and support ring or base plate ensure stability during use, while the handles allow for safe and convenient handling, even when the insert is hot. For users who need to cook larger quantities, the stacking alignment features, and interlocking mechanism ensure secure stacking of multiple inserts, increasing cooking capacity without compromising stability. Measurement markings aid in precise portion control for dietary or baby food preparation. Compact storage features allow the insert and its components to nest, addressing space constraints in kitchens. By integrating all these elements, the base frame 11 unifies the product into a cohesive and reliable cooking solution. This design offers a superior alternative to traditional cooking methods and existing products, addressing inefficiencies while enhancing user convenience and safety.

A method of making the subject disclosure may include the following. The first step involves creating a conceptual design using computer-aided design (CAD) software. This design incorporates all functional features, such as compartment shapes, measurement markings, stacking alignment features, and the interlocking mechanism. Prototypes are developed using 3D printing or similar technologies, which are then tested for fitness, functionality, and compatibility with standard cooking pots. The design is iterated based on the feedback from these tests. The next step is selecting appropriate materials for each component. Measurement markings are embossed, engraved, or laser-etched to ensure readability and longevity. During the manufacturing process, silicone components are created using injection molding for precision and uniformity. The base frame and support ring are fabricated using stamping, die-casting, or CNC machining. The non-slip base is molded or adhered to the underside of the base frame, and all components are assembled with secure attachments. The stacking alignment features, and interlocking mechanisms are integrated to ensure modular compatibility, and measurement markings are added as finishing touches.

Multiple flush compartments are necessary for separating foods and allowing them to cook simultaneously without cross-contamination. The base frame with a non-slip feature is vital for providing stability during use and ensuring the insert remains securely positioned within the pot. Stacking alignment features and interlocking mechanisms are also necessary to allow multiple inserts to be stacked for increased cooking capacity, adding versatility to the product. Optional elements include measurement markings which may not always be necessary. Compact storage design, while beneficial for saving space, is not essential for the basic operation of the insert. Ergonomic handles can improve handling, but the product can still function without them. Similarly, color-coding for compartments is useful for organization but does not impact the performance of the insert in preparing food. Elements to improve the subject disclosure are integrating a timer or temperature sensors would provide users with real-time feedback on cooking progress, reducing the risk of overcooking or undercooking. Adjustable compartment sizes could allow users to modify the compartments based on the type or quantity of food being prepared. The subject disclosure embodies version of the cookware insert with no divider walls.

To use the subject disclosure and solve the problem of efficiently preparing multiple foods simultaneously while reducing time, effort, and cleanup, the user would follow a straightforward process. First, they would prepare the cooking pot insert and ingredients. This begins by selecting an appropriately sized pot that accommodates the insert and ensures the insert is clean and free of debris. The user would then prepare the ingredients, such as washing, peeling, chopping, or portioning them according to the recipe. The measurement markings on each compartment can help ensure accurate portions and consistent cooking results. Next, the user would arrange the ingredients in the compartments. Each type of food, such as vegetables, grains, or proteins, would be placed into a designated compartment. Care should be taken not to overfill the compartments, as this could interfere with the cooking process or lead to uneven results and/or overflow. Once the ingredients are in place, the user would position the insert into the pot. The base frame with its non-slip feature ensures stability during use. If using multiple inserts, the user would align them carefully with the stacking alignment features and interlocking mechanisms to ensure secure and even stacking. After assembling the insert, the user would proceed to cook the ingredients. They would add water or broth to the pot, ensuring the liquid level remains below the edge of the compartments to prevent overflow. The pot lid would then be placed securely to retain steam and promote even cooking. The pot is then placed on the stove, and the heat is adjusted as needed. During the cooking process, the user may monitor and adjust as necessary. For example, they can modify the heat or cooking time based on the specific needs of the ingredients. If multiple stacked inserts are used, the user can carefully remove the top insert when its contents are done, allowing the lower compartments to continue cooking. Once cooking is complete, the user would remove the insert from the pot using the ergonomic handles, which ensure safe and easy handling. After allowing the insert to cool slightly, the cooked food can be removed from each compartment and served directly or transferred to plates or storage containers. Finally, the user would clean and store the components. The compartments, base frame, lid, and other parts should be washed with warm water and dish soap, and the non-stick coating simplifies this process. After drying, the components can be nested or stacked for compact storage, minimizing their use of kitchen space. By following these steps, the user can efficiently prepare multiple foods in a single pot, reducing cooking time and cleanup while encouraging healthier homecooked meals. This process directly addresses the inefficiencies and inconveniences associated with traditional cooking methods.

Additionally, the cookware insert 10, while designed primarily for preparing multiple foods simultaneously in a single pot, can be adapted for use in other fields or applications beyond its original intent. For instance, in the field of food production and meal preparation, the invention could be utilized in commercial kitchens, catering services, or meal prep businesses. Its ability to separate ingredients during cooking would streamline batch cooking processes, allowing chefs to prepare multiple components of a dish at once while maintaining their distinct flavors and textures. In addition, the invention could be adapted for laboratory or research applications. For example, in food science laboratories, the compartments could be used to test different cooking methods, times, or temperatures on various food samples simultaneously or even used in scientific experiments. This would enable researchers to conduct controlled experiments more efficiently. The subject disclosure could also find utility in the field of materials science or chemical engineering. The leak-proof compartments and stackable nature of the insert make it ideal for processes that require simultaneous heating or steaming of multiple substances while keeping them isolated. This could be useful in developing or testing new materials, where controlled heating in separate compartments is essential to prevent cross-contamination. Lastly, the compact and organized nature of the cooking pot insert makes it suitable for space-saving solutions in confined environments, such as in space stations, submarines, or other remote settings where cooking or heating multiple items simultaneously in limited space is critical. Its versatility and adaptability could provide innovative solutions in a variety of technological and operational contexts.

Also, the subject disclosure is a versatile and innovative tool that can produce a wide range of products, compositions, and useful items across various applications. In the culinary field, it allows for the preparation of multiple food components simultaneously, such as steamed vegetables, proteins, grains, legumes, sauces, and broths, all without mixing flavors or textures. This feature is particularly beneficial for meal prep, where different food components can be cooked in one pot, saving time and minimizing cleanup. For those with specific dietary needs, individuals and small families, the insert can be used to prepare allergy-friendly meals or custom meals for specific diets, such as keto, vegan, or gluten-free. In addition, it is ideal for making homemade baby food by steaming purees for different vegetables and fruits, or for preparing individual servings of food for meal prep and portion control. The insert also has applications beyond the kitchen. In laboratory or industrial settings, it can be used for material or chemical composition testing, as its leak-proof compartments allow substances to be heated or steamed simultaneously without cross-contamination. This feature is also beneficial in pharmaceutical or medical settings for sterilizing instruments or preparing medicinal compounds in controlled environments. The insert can be applied to creative fields like candle or soap making, where different components can be heated in separate compartments to maintain distinct colors or scents. In remote environments, such as camping or during travel, the insert offers a compact solution for preparing multiple meal components in confined spaces. Additionally, it can be used for pet food preparation, allowing for the simultaneous cooking of various pet meals. The cooking pot insert's design makes it an adaptable tool that simplifies cooking processes, enhances efficiency, and allows for greater versatility in both culinary and non-culinary applications.

As used in this application, the term “about” or “approximately” refers to a range of values within plus or minus 10% of the specified number. And the term “substantially” refers to up to 80% or more of an entirety. Recitation of ranges of values herein is not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other. The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A cookware insert, comprising
a base wall dimensioned and shaped to circumscribe a portion of a contained volume a cookware;
a plurality of divider walls extending from the base wall and dividing the portion of the contained volume into a plurality of compartments; and
the lower surface of each divider wall of the plurality of divider walls having a flush alignment relative to each other so that fluids contained by one compartment of the plurality of compartments is prevented from migrating to an adjacent compartment of the plurality of compartments.

2. The cookware insert of claim 1, wherein the base wall and the plurality of divider walls are sufficiently heat resistant for cooking various food stuff in the plurality of compartments.

3. The cookware insert of claim 2, a hub centrally disposed in the portion of a contained volume the cookware, wherein the plurality of divider walls terminate at the central hub.

4. The cookware insert of claim 3, a handle portion projecting from the beyond an upper surface of the plurality of divider walls.

5. The cookware insert of claim 4, a nesting receptacle defined by the hub.

6. The cookware insert of claim 5, a lower edge of the base wall providing a series of locking grooves.

7. A cookware insert system, comprising:
two or more cookware inserts of claim 6 dimensioned and shaped so that each of the two or more said cookware inserts form a nested condition when in a vertically stacked arrangement, wherein a handle portion of a subjacent cookware insert of the two or more said cookware inserts is received within a nesting receptacle of a suprajacent cookware insert of the two or more said cookware inserts, and wherein one or more of the series of locking grooves of said suprajacent cookware insert engages one of the plurality of divider walls.
